(19) United States
(12) Patent Application Publication
(10) Pub. No.: US 2026/0332091 A1
(43) Pub. Date: Oct. 22, 2026

(54) RENEWABLE ENERGY POWER PLANT BACKFILLING USING NATUREMOUNT ASSEMBLIES

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/631,138

(22) Filed: Mar. 27, 2026

Related U.S. Application Data
(60) Provisional application No. 63/778,742, filed on Mar. 27, 2025.

(51) Int. Cl. H02S 40/36; H02J 3/38; H02J 101/24; H02J 101/28; H02S 10/00; H02S 20/32

(52) U.S. Cl. CPC H02S 40/36; H02J 3/38; H02S 10/00; H02S 20/32; H02J 2101/24; H02J 2101/28

(57) ABSTRACT

A system for backfilling a renewable energy power plant includes a solar panel array, a first electrical interconnection, and a second electrical interconnection. The solar panel array includes a first set of solar panels, each configured to be positioned between at least one pair of adjacent rows of solar panels from a second set of solar panels different from the first set of solar panels, the second set of solar panels being legacy solar panels and electrically coupled to an electrical grid via the first electrical interconnection. The second electrical interconnection is different from the first electrical interconnection, is operably coupled to the first plurality of solar panels, is not operably coupled to the second plurality of solar panels, is not operably coupled to the electrical grid, and is configured to connect to at least one of a behind-the-meter load or a behind-the-meter storage.

### CROSS-REFERENCE TO RELATED APPLICATIONS

This application claims priority to U.S. Provisional Patent Application No. 63/778,742, filed Mar. 27, 2025 and titled “RENEWABLE ENERGY POWER PLANT BACKFILLING USING NATUREMOUNT ASSEMBLIES,” the content of which is incorporated by reference herein in its entirety.

### FIELD

The present disclosure relates to energy generation, and more specifically, to systems and methods for increasing the output of renewable energy power plants.

### BACKGROUND

A solar farm is a large collection of solar (e.g., photovoltaic) panels typically arranged in rows and configured to convert sunlight into electricity. Some solar farms require 5-10 acres of land per megawatt (MW) of capacity.

### SUMMARY

In some embodiments, a system for backfilling a renewable energy power plant includes a solar panel array, a first electrical interconnection, and a second electrical interconnection. The solar panel array includes a first set of solar panels, each configured to be positioned between at least one pair of adjacent rows of solar panels from a second set of solar panels different from the first set of solar panels, the second set of solar panels being legacy solar panels and electrically coupled to an electrical grid via the first electrical interconnection. The second electrical interconnection is different from the first electrical interconnection, is operably coupled to the first plurality of solar panels, is not operably coupled to the second plurality of solar panels, is not operably coupled to the electrical grid, and is configured to connect to at least one of a behind-the-meter load or a behind-the-meter storage.

In some embodiments, a system for backfilling a renewable energy power plant includes a plurality of solar panel arrays and an electrical connection. The plurality of solar panel arrays includes a first solar panel array and a second solar panel array, the first solar panel array being positioned between a first row of legacy renewable energy sources (LRES's) from a plurality of rows of LRES's and a second row of LRES's from the plurality of rows of LRES's, and the second solar panel array being positioned between the second row of LRES's from the plurality of rows of LRES's and a third row of LRES's from the plurality of rows of LRES's. The electrical interconnection is operably coupled to the plurality of solar panel arrays, is not operably coupled to the plurality of rows of LRES's, is not operably coupled to an electrical grid, and is configured to connect to at least one of a behind-the-meter load or a behind-the-meter storage.

In some embodiments, a system for backfilling a renewable energy power plant includes a solar panel array, a first electrical interconnection, and a second electrical interconnection. The solar panel array includes a first set of solar panels that are not on trackers, each solar panel from the first set of solar panels configured to be positioned between at least one pair of adjacent rows of solar panels from a second set of solar panels different from the first set of solar panels. The second set of solar panels includes legacy solar panels that are on trackers, and is electrically coupled to an electrical grid via the first electrical interconnection. The second electrical interconnection is different from the first electrical interconnection, is operably coupled to the first plurality of solar panels, is not operably coupled to the second plurality of solar panels, and is configured to connect to at least one of a behind-the-meter load, a behind-the-meter storage, or the electrical grid.

In some embodiments, a method for backfilling a renewable energy power plant includes positioning a solar array between a first legacy renewable energy source (LRES) and a second LRES that are electrically coupled to an electric grid, the first LRES and the second LRES being collocated at a common geographic site. The method also includes electrically coupling, after the positioning, the solar array to at least one of a behind-the-meter load or a behind-the-meter storage, the solar array not being electrically coupled to the electric grid.

In some embodiments, a method for backfilling a renewable energy power plant includes positioning a solar array between a first legacy renewable energy source (LRES) and a second LRES that are electrically coupled to an electric grid, the first LRES and the second LRES being collocated at a common geographic site. The method also includes electrically coupling, after the positioning, the solar array to at least one of a behind-the-meter load, a behind-the-meter storage, or the electric grid.

### BRIEF DESCRIPTION OF THE DRAWINGS

FIG. 1 is a diagram of a known arrangement of windmills in a wind farm/power plant.

FIG. 2 is a diagram showing a plan view of a known solar power plant having approximately 33% ground coverage ratio (GCR).

FIG. 3 is a block diagram of a solar power plant including a solar panel array, in accordance with some embodiments of the present disclosure.

FIG. 4 is a diagram showing an example layout of a solar power plant including rows of legacy solar panels on trackers and intervening rows of solar panels on racks, in accordance with some embodiments of the present disclosure.

FIG. 5 is a photograph of solar modules on wheeled metal racks in accordance with some embodiments.

FIG. 6 is a flow diagram showing a method for backfilling a renewable energy power plant, in accordance with some embodiments.

FIG. 7 is a flow diagram showing a method for backfilling a renewable energy power plant, in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

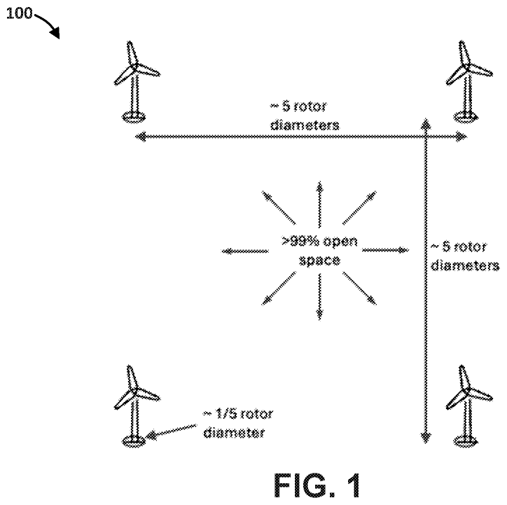

Many existing, legacy renewable power plants (LRPPs) have substantial amounts of underutilized land (e.g., open ground). In the case of a wind energy plant, for example, each wind turbine is typically mounted on a support tower whose base stands on a heavy foundation. For a large wind turbine (e.g., having a rotor diameter of about 125 meters (m.) or about 410 feet (ft.)), this foundation may be approximately 25 m./82 ft. in diameter, and the towers may be spaced approximately 625 m./2,050 ft. apart. As a result, more than 99% of the surface area devoted to the wind energy plant is unused at the surface. FIG. 1 is an example diagram of such a known arrangement of wind turbines in a wind energy plant. Wind energy plants such as these do not use most of their surface area.

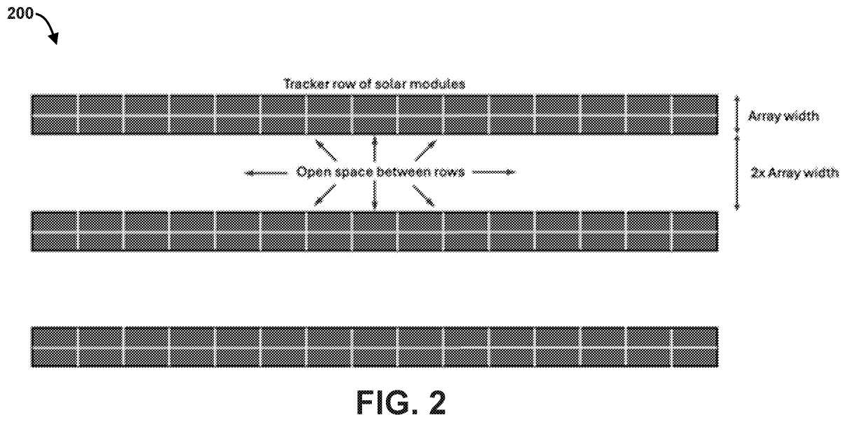

In the case of solar power plants, the ground coverage ratio (“GCR”) is the ratio of the area of the solar array to the land area. For arrays using single-axis trackers (as is the case in some known utility-scale solar arrays), GCRs tend to range from approximately 0.40 in the sun belt to 0.25 at 55-60 degrees from the equator. In other words, between 60% and 75% of the land area assigned to a single-axis tracker array is typically unused at the surface, in that the surface is not directly below a solar module (although portions thereof may be in the shade of one for part of the day). FIG. 2 is a diagram showing a plan view of a known solar power plant having approximately 33% ground coverage ratio.

Some known solar panel configurations include single-axis trackers whose long axis runs north-south. The solar panels are typically tilted from east-facing in the morning to west-facing in the late afternoon. At noon, the panels typically don't actually face the sun, which is off to the south in the Northern Hemisphere and to the north in the Southern Hemisphere; rather, they face straight up. The panels are typically tilted steeply in the morning and late afternoon, and the sun at those times is relatively low in the sky. The panels therefore cast long shadows. If the rows are placed too close together, then each row will at least partially shade the one behind it. Shadows have a disproportionately undesirable impact on solar production because the portion of each panel that is in shadow will have less current flowing through it and, rather than contributing to energy production, can resist energy production and become hot, dissipating energy from the rest of the panel/array. Historically, with panel costs being high, it was important to maximize energy production per panel—which is why trackers exist in the first place. Some designers found that it was desirable to separate the tracker rows significantly. In some instances, the optimal GCR for tracker systems was determined to be about 33%, leaving ⅔ of the ground unoccupied.

The open land available at existing, legacy renewable power plants (LRPPs) creates an opportunity to introduce one or more add-on renewable power plants (ARPPs) using the open land area, thereby increasing the overall renewable energy output from the same real estate. Specifically, this can be done using a process referred to herein as “surface infill solar,” whereby one or more solar arrays are placed on (or effectively on, adjacent to, in close proximity to (e.g., within 1-12 inches thereof), above, etc.) the surface/open land area, for example between or adjacent to existing pieces of infrastructure of the LRPP.

One or more embodiments of the present disclosure includes a method and system for increasing a total energy produced on land allocated to/occupied by an LRPP (e.g., an existing solar power plant, an existing wind generating plant, etc.). Depending on the implementation, the increase to the total energy that is produced on the land allocated to/occupied by the LRPP, or that is capable of being produced (i.e., the energy production capacity thereof) on that land, can be permanent, or the energy produced by (or energy production capacity of) the LRPP can be temporarily augmented/increased, for example during a maintenance, overhaul or upgrade process that includes taking some existing capacity offline.

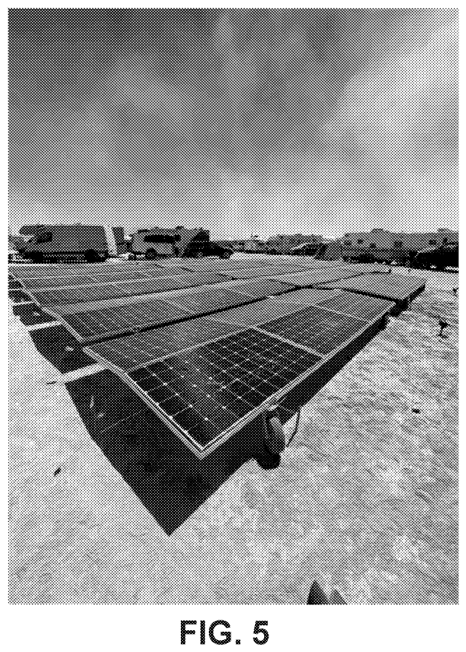

As panel costs decrease, it can be desirable to place new solar panels (e.g., solar panels that are being added to an existing system) on the ground, for example to avoid the cost of using a tracker(s), even if the solar panels will be in the shadow of existing tracker-mounted modules for parts of the morning/afternoon. If all solar modules are placed on the ground, aimed straight up to the sky, they would all produce peak power at approximately noon/midday. When solar modules are arranged in a tent-shaped array (e.g., a plurality of inverted V arrays, as shown in FIG. 5 and/or in accordance with one or more embodiments of the present disclosure), however, they are not all aimed straight up to the sky; instead, they are slightly tilted. If the long axis of each inverted V array is aligned with the tracker rows, i.e., north-south, then the modules on the east side of the inverted-V array will be tilted slightly to the east, and the modules on the other side will be tilted slightly to the west. This will mean that the modules on one side will produce more energy during the morning and less in the afternoon; while those on the other side will produce more in the afternoon and less in the morning. This tent-shaped array configuration results in a broader production profile than a strictly planar configuration—not as strongly peaked at noon but with more production in the morning (due to the east-tilted modules) and afternoon (due to the west-tilted modules) than would be obtained using a planar configuration.

In some embodiments, the role of an energy management system (“EMS”) is to decide and/or control what power should flow to where, and at/during what time. In a power plant including a solar array and an energy storage, all power from the solar array may be delivered to a single place/location. The solar array and the energy storage will typically be co-located, optionally with a connection to the electrical grid. As such, the energy storage (e.g., ESS, battery, etc.) has power available during the day from the solar array. The EMS may decide whether to direct that power to the electrical grid, use some of that power to charge a battery, direct the inverters in the solar array to curtail the solar production because there's too much to send to the electric grid and the battery taken together (perhaps because of the battery's power limit, or because the battery is full), and/or the like. During the evening there may be little or no power available from the solar array, in which case the EMS may decide how quickly to discharge the battery into the grid. The EMS may be capable of (e.g., configured to) accepting direction/instructions from a user via an interface (e.g., a plant operator or grid system operator), telling the EMS how to dispatch and direct power.

One or more embodiments set forth herein include the use of ground-mounted solar array “racks” that are placed between and/or adjacent to the installed equipment of the LRPP. For example, if the LRPP is a solar array using single-axis trackers (e.g., arranged in rows, referred to herein as “tracker rows”), each of the solar array racks that are added/introduced may be placed on or near the ground between two adjacent tracker rows from the tracker rows.

The additional energy produced by the solar array racks may be used to, for example, one or more of:

Back-fill when the output power of the LRPP is lower than the LRPP's maximum power limit, either because of normal output variations (e.g., due to weather conditions) or because a portion of the LRPP is offline.

Charge an energy storage system (ESS) such as a battery, which may have been part of the LRPP and/or which may be added along with the solar array racks, for example so that power can be delivered later in the evening (and/or earlier the following morning) than would otherwise be possible with the LRPP.

Deliver power to a behind-the-meter electrical load, which could be relatively small (such as auxiliary loads associated with the LRPP) or could be relatively large (such as an industrial plant located adjacent to the power plant). In either of these cases the production system may be, but need not be, configured to deliver energy to an electrical grid.

The surface infill solar process can be implemented using, for example, one or more solar modules that are mounted in portable “rack” structures, optionally that have been factory-assembled (including associated wiring) before being transported to an installation site, such that on-site workers can deploy the solar modules as arrays quickly and with minimal technical work, placing them on the surface and using any of several methods to secure them in place. In some locations, it may not even be necessary to secure the racks in place, relying solely on their weight and low wind exposure, or varying degrees of securement may be warranted, depending on the installation environment. Similarly, the module racks may be configured (e.g., sized, shaped and/or designed) to be removed from the installation site quickly, with minimal technical work. As used herein, “installation” may refer to a temporary, a semi-permanent, or a permanent installation. Additional implementation details compatible with systems and methods described herein can be found, by way of example only, in U.S. Pat. No. 11,862,980 (“AC Overbuild Add-On”), the entire contents of which are incorporated by reference herein for all purposes.

As used herein, the term “NatureMount” can refer, by way of example, to a solar module mounting structure that reduces or minimizes a grading of a terrain, a levelling of a terrain, and/or an amount/presence of a foundation in connection with the placement of the solar module(s) on natural land (e.g., earth), or that that reduces or minimizes an impact of a grading of a terrain, a levelling of a terrain, and/or an amount/presence of a foundation in connection with the placement of the solar module(s) on natural land (e.g., earth). Stated another way, NatureMount can refer to a system that is “field-deployable” and/or that facilitates placement of solar module(s) on natural land with a reduced amount of preparation of the natural land location, as contrasted with known systems/methods.

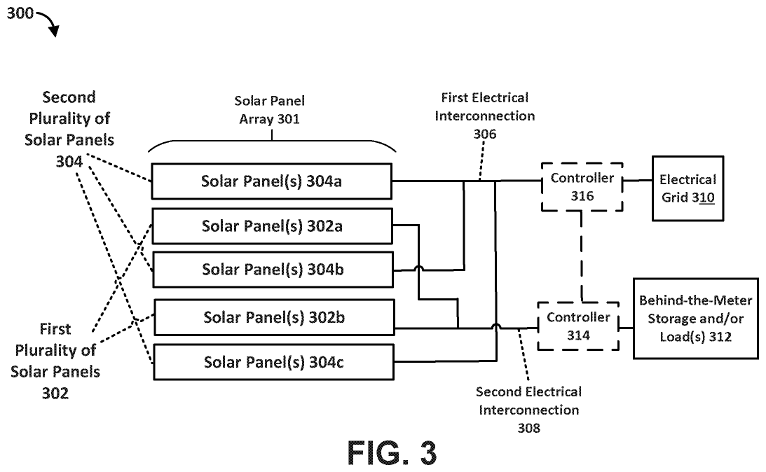

FIG. 3 is a block diagram of a “NatureMount” system for backfilling a renewable energy power plant, in accordance with some embodiments of the present disclosure. As shown in FIG. 3, the system 300 includes a solar panel array 301, a first electrical interconnection 306, and a second electrical interconnection 308. The solar panel array 301 includes a first plurality of solar panels 302 (solar panels 302a, 302b) that are not on trackers, each solar panel from the first plurality of solar panels 302 configured to be positioned between at least one pair of adjacent rows of solar panels from a second plurality of solar panels 304 (solar panels 304a, 304b, 304c) different from the first plurality of solar panels 302. Here, one feature being described as “different” from a second feature is understood to mean that the second feature is at least a separate physical entity to the first feature. “Different” does not necessarily mean that the two features are technically different (i.e. that their construction or functionality is not the same). For example, a second plurality of solar panels that are described as “different”′ to a first plurality of solar panels is understood to mean that the second plurality is a separate physical instance to the first plurality of solar panels, not that the second plurality of solar panels necessarily functions or is constructed differently to the first plurality of solar panels (however this could be the case if such features are also defined). In some embodiments, the solar panel array 301 may comprise the first plurality of solar panels 302 and the second plurality of solar panels 304. In other embodiments, the second plurality of solar panels 304 may not be included in the solar panel array 301. The second plurality of solar panels 304 includes legacy solar panels that are on trackers, and is electrically coupled to an electrical grid 310 via the first electrical interconnection 306. The second electrical interconnection 308 is different from the first electrical interconnection 306, is operably coupled to the first plurality of solar panels 302, is not operably coupled to the second plurality of solar panels 304, and is configured to connect to at least one of a behind-the-meter load 312 or a behind-the-meter storage 312, but not the electrical grid 310. (Note: in other implementations, the second plurality of solar panels 304 may be configured to connect to at least one of the behind-the-meter load 312, the behind-the-meter storage 312, or the electrical grid 310.) As used herein, a “tracker” refers to a mechanical device whose position is automatically and/or manually adjustable such that a solar panel coupled thereto follows (or “tracks”) a movement of the sun across the sky, and such that the solar panel is oriented to increase (e.g., maximize) an amount of sunlight incident on the solar panel (and, hence, an amount of energy production of the solar panel). Optionally, the system 300 includes a first controller 314 configured to control the delivery of electricity from the first plurality of solar panels 302 to the behind-the-meter load 312 and/or the behind-the-meter storage 312. Alternatively or in addition, the system 300 can include a second controller 316 configured to control the delivery of electricity from the second plurality of solar panels 304 (but not the first plurality of solar panels 302) to the electrical grid 310. At least one of the first controller 314 or the second controller 316 can comprise one or more of: a compute device, a transceiver configured to communicate with at least one other compute device, a memory, instructions to control one or more switches or electrical bridges, and/or an electronic device/component that regulates voltage and current supplied by a solar panel(s) (e.g., to a battery/ESS, a load and/or a behind-the-meter load).

The first plurality of solar panels 302 can be different from the second plurality of solar panels 304 in that (1) the first plurality of solar panels 302 do not include trackers while the second plurality of solar panels 304 do include trackers, (2) the first plurality of solar panels 302 are an ARPP(s) while the second plurality of solar panels 304 are an LRPP(s), and/or (3) the first plurality of solar panels 302 are closer to the ground/supporting surface than is the second plurality of solar panels 304.

In some implementations, the first controller 314 and the second controller 316 are part of the same physical compute device, are operatively coupled to each other and/or operate in a coordinated manner (e.g., as an EMS) to control energy delivery from all solar panels (302a-302b and 304a-304c) of the solar panel array 301. In other implementations, the first controller 314 is configured to communicate (e.g., via a wireless and/or a wired network) with the second controller 316, for example such that an energy production of the first plurality of solar panels 302 may be taken into account by the second controller 316 when the second controller 316 controls the delivery of electricity from the second plurality of solar panels 304 to the electrical grid 310, and/or such that an energy production of the second plurality of solar panels 304 may be taken into account by the first controller 314 when the first controller 314 controls the delivery of electricity from the second plurality of solar panels 304 to the behind-the-meter load 312 and/or the behind-the-meter storage 312.

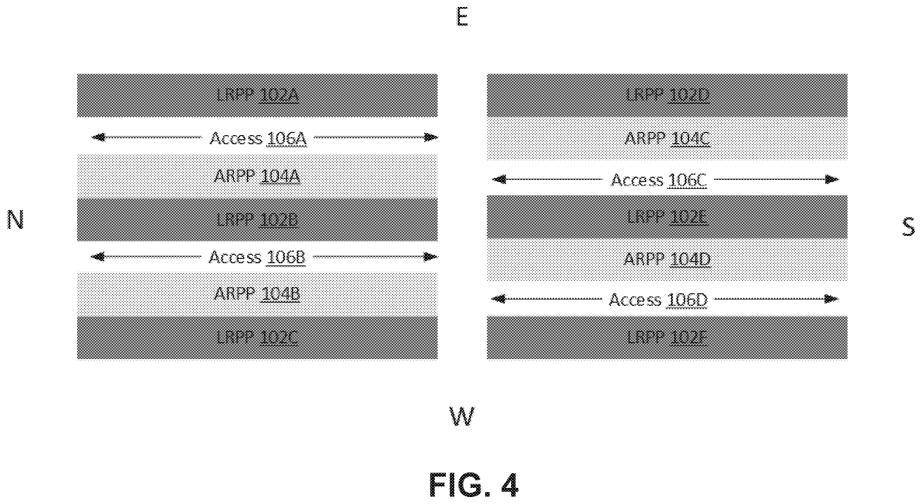

FIG. 4 is a diagram showing an example physical layout of a solar power plant including rows of LRPPs, intervening rows of ARPPs, and access lanes (also referred to herein as “access paths”), in accordance with some embodiments of the present disclosure. Here, “legacy” is understood to mean pre-existing, and thus can be used to describe any item (solar panel, for example) that is already installed at a location, for example at the time of a system upgrade or reconfiguration. Since some known LRPPs run/are oriented in a north-south direction, the left side of FIG. 4 can be considered north (labelled “N” in FIG. 4) and the right side can be considered south (labelled “S” in FIG. 4), so that the top of FIG. 4 is east (labelled “E”′ in FIG. 4) and the bottom is west (labelled “W” in FIG. 4). In FIG. 4, the left (north) side includes: three LRPPs 102A, 102B, 102C; two ARPPs 104A, 104B; and two access lanes 106A, 106B. The right (south) side also includes: three LRPPs 102D, 102E, 102F; two ARPPs 104C, 104D; and two access lanes 106C, 106D. Each ARPP is located between a unique pair of LRPPs, and access lanes are located (1) adjacent (at one of the east or west side) to the ARPPs and (2) between the north and south sides.

In FIG. 4, on the left (north) side, the ARPPs are positioned to the west side of their respectively adjacent access lanes; on the right (south) side the ARPPs are positioned to the east side of their associated adjacent access lanes. This configuration provides some mitigation of the shading of the ARPPs from the sun by the LRPPs; the ARPPs on the left side of FIG. 4 would be more affected by shadows in the evening, and the ARPPs on the right side would be more affected by shadows in the morning. Depending on the implementation, the access lanes can have any of a variety of different widths. For example, one or more of the access lanes may have a width that is approximately half of the distance between adjacent LRPPs, or that is approximately one-third of the distance between adjacent LRPPs, or that is between 1-2 feet, or that is between 1-5 feet, or that is between 2-5 feet. The access lane distance(s) may, in some implementations, have a width that is sufficient to accommodate a human maintenance person, a robot, etc.

The installation method illustrated by FIG. 4 involved installing the ARPPs in a pattern that leaves access lanes but also positions the ARPPs (1) to reduce (e.g., minimize) shading in the morning, if morning energy has more value (e.g., as determined by an EMS) than late afternoon/evening energy; (2) to reduce (e.g., minimize) shading in the late afternoon/evening, if late afternoon/energy has more value (e.g., as determined by the EMS) than morning energy; or (3) in an alternating pattern to approximately equalize shading between morning and afternoon/across a day.

FIG. 5 is a photograph of solar modules (e.g., similar to the ARPPs of FIG. 4) on wheeled metal racks (a “rack design”), in accordance with some embodiments. This implementation places each of the modules in a relatively flat inverted “V” configuration, which facilitates cleaning of the panels (e.g., by rain or by water sprayed toward the array) by ensuring that incident water runs off, carrying dust away rather than drying on the panels and re-depositing dust on them. Also, if the long axis of each array is oriented north-south (which, in some implementations, would also align them with tracker rows), this design slightly broadens the production profile of the solar array, in that while peak production may be reduced around mid-day, production earlier in the morning and later in the afternoon are increased. The wheels enable the workers to reposition the racks quickly and easily (e.g., nearby LRPP's), without having to carry them. Once the racks are in place, the wheels may optionally be removed to ensure the rack does not move in a strong wind. Removed wheels may be re-used to move another rack and/or may be reinstalled when/if the original rack(s) is to be moved again.

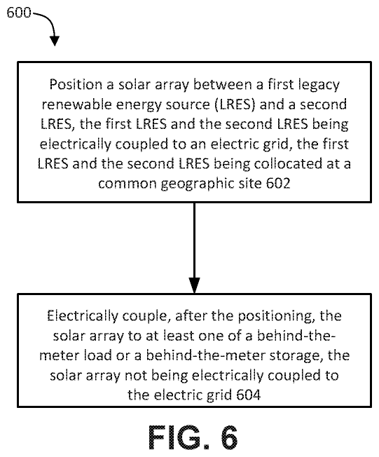

FIG. 6 is a flow diagram showing a method 600 for backfilling a renewable energy power plant, in accordance with some embodiments. As shown in FIG. 6, the method 600 includes positioning, at 602, a solar array between a first legacy renewable energy source (LRES) and a second LRES. The first LRES and the second LRES are electrically coupled to an electric grid. The first LRES and the second LRES are collocated at a common geographic site. Here, “collocated at a common geographic site” means that the items are all located in the same broad area of land. For example, two solar panel arrays could be collocated/deployed in the same field, spaced a few meters (m) apart. The phrase “collocated at a common geographic site” is not to be taken to mean that multiple items are stacked at identical precise geographic coordinates, but rather that they are placed/positioned in a common, identifiable area, for example having a proximity to one another of within about 100 m, about 80 m, about 60 m, about 50 m, about 40 m, about 20 m, about 10 m, about 5 m and/or any other distance of similar magnitude. The method 600 also includes electrically coupling, at 604 and after the positioning at 602, the solar array to at least one of a behind-the-meter load or a behind-the-meter storage, the solar array not being electrically coupled to the electric grid. (Note: in other implementations, the solar array may be configured to connect to at least one of a behind-the-meter load, a behind-the-meter storage, or the electric grid.)

In some implementations of the method 600, at least one of the first LRES or the second LRES includes an array of solar cells and at least one single-axis tracker. An access lane may be defined between subsets of solar cells from the array of solar cells. Alternatively or in addition, at least one of the first LRES or the second LRES can include an array of wind turbines, an access lane being defined between an edge of the solar array and the array of wind turbines.

In some implementations, the method 600 also includes selecting, before the positioning, a location for the solar array based on a relative value of energy supplied by the solar array during a morning portion (e.g., between midnight and noon) of a day, and the positioning includes positioning the solar array at the location. The location can be between the first LRES and the second LRES.

In some implementations, the method 600 also includes selecting, before the positioning, a location for the solar array based on a relative value of energy supplied by the solar array during an evening portion (e.g., between 5 PM and 8 or 9 PM) of a day, and the positioning includes positioning the solar array at the location. The location can be between the first LRES and the second LRES.

In some implementations, the method 600 also includes selecting, before the positioning, a location for the solar array based on an amount of shading of the solar array during a predefined portion of a day, and the positioning includes positioning the solar array at the location. The location can be between the first LRES and the second LRES.

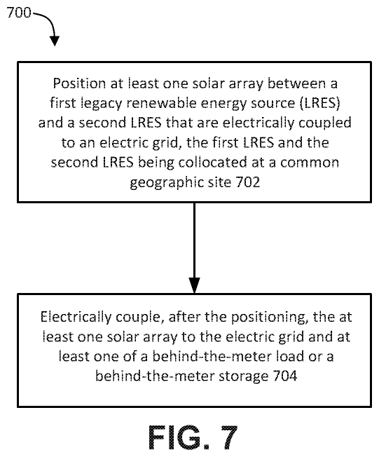

FIG. 7 is a flow diagram showing a method 700 for backfilling a renewable energy power plant, in accordance with some embodiments. As shown in FIG. 7, the method 700 includes, at 702, positioning at least one solar array between a first legacy renewable energy source (LRES) and a second LRES that are electrically coupled to an electric grid, the first LRES and the second LRES being collocated at a common geographic site. The method 700 also includes, at 704, electrically coupling, after the positioning, the at least one solar array to the electric grid and at least one of a behind-the-meter load or a behind-the-meter storage.

In some implementations, the method 700 also includes repositioning at least one of the first solar array or the second solar array during a repowering of at least one of the first LRES or the second LRES.

In some implementations, the at least one solar array includes a plurality of solar arrays, the method further comprising repositioning a first subset of solar arrays from the plurality of solar arrays on an eastward side of the common geographic site, and repositioning a second subset of solar arrays from the plurality of solar arrays on a westward side of the common geographic site, to mitigate shading effects. The eastward side can be the side that is at least east of the center of the common geographic site and can be the side that is farthest east of the common geographic site, that can be referred to as the eastmost side. The westmost side can be the side that is at least west of the center of the common geographic site and can be the side that is farthest west of the common geographic site, that can be referred to as the westmost side. The solar arrays from the first subset of solar arrays can be electrically connected in series in a first circuit, and the solar arrays from the second subset of solar arrays can be electrically connected in series in a second circuit that is different from, and not electrically connected to, the first circuit.

In some implementations of method 700, the at least one solar array is positioned in an access lane between the first LRES and the second LRES, and method 700 further includes repositioning the at least one solar array on one of an eastmost side or a westmost side of the access lane to mitigate shading effects. In some implementations, the access lane is a first access lane, the at least one solar array is a first subset of solar arrays from a plurality of solar arrays, and method 700 further includes repositioning a second subset of solar arrays from the plurality of solar arrays on one of the eastmost side or the westmost side of a second access lane defined in part by a third LRES. In some implementations, solar arrays from the first subset of solar arrays are electrically connected in series in a first circuit, and solar arrays from the second subset of solar arrays are electrically connected in series in a second circuit that is different from, and not electrically connected to, the first circuit.

### Stringing (Wiring) Considerations

Some known solar modules are wired in series, such that their voltages add. In other words, the total voltage provided by one or more solar modules wired in series is equal to the sum of the voltages provided by each of the one or more solar panels. A single series of solar modules wired in this way can be referred to as a string. When the string is sufficiently long, energy can be delivered to a DC-coupled battery energy storage system (“BESS”), and/or to an inverter for transmission to an electric grid, and/or to an AC-coupled BESS, and/or to one or more other Power Conditioning Systems (PCS's) for voltage conversion for some other use. The length at which the string is sufficiently long can depend on the voltage to be supplied to the devices that the string is connected to, and on the amount of voltage developed/generated by each solar module. For example, if 1,000V-1,500 V is to be supplied to the connected device(s) and each solar module has a maximum voltage of ~50V, a string of solar modules could include between 20 and 30 modules. In some implementations, the shorter the string of solar modules, the lower will be the voltage and power delivered to the device (e.g., BESS, inverter, etc.), and below some identifiable threshold number of solar modules, the connected device(s) may shut off and not accept power.

A consequence of wiring the modules in series is that the same current flows through every module. If one module is strongly sunlit while another is in shade, the module in shade may absorb power rather than generating it—in other words, the shaded module may act as an electrical resistor rather than as an energy source. This can result in a loss of power from the system but can also result in heating of the shaded module, which can shorten its life. It is, therefore, desirable if all the modules in a string are similarly or equally lit (or in shade). In view of this, in the case of an infill solar array (sometimes referred to herein as “ARPP”) being added to an existing (legacy) solar site (sometimes referred to herein as an “LRPP” or “LRES”) equipped with single-axis trackers, the infill solar array can be positioned with the long axis of the infill solar array running in/being parallel or substantially parallel with the tracker axis. In so doing, shadows from the tracking array will fall on all the modules on one side of an infill solar array at the same time. By arranging the wiring of the infill solar array so that modules in series are all on the same side of the infill solar array, mismatched shading can be reduced (e.g., minimized).

### Example Use Cases

In some embodiments, increasing the output of an LRPP solar power plant can be accomplished by placing an infill solar array on the ground between the tracker rows of the LRPP. The energy generated by the infill solar array can then be routed to:

one or more existing points of electrical grid interconnection, such that power can be delivered to the grid whenever the LRPP's power output falls below a level that can be accepted by the electrical grid at that point of interconnection; and/or

an energy storage system (ESS), where the energy can be stored until the operator of the ARPP desires to deliver the energy to the electrical grid.

In some such implementations, the electrical operation of the LRPP is not modified in any way and is not affected by energy deliveries from the infill solar array, which effectively “works around” the energy deliveries from the LRPP. This can have value if, for example, the LRPP has a Power Purchase Agreement (PPA) at a very attractive (e.g., high) price, where the validity of the PPA might be impacted by any change in the operation of the LRPP. By implementing one or more systems and methods described herein, the LRPP can continue to deliver under its PPA, unaltered and unaffected by the presence of the infill solar array.

In some embodiments, infill solar array racks are placed between tracker rows of an LRPP such that the spaces between adjacent tracker rows are not entirely filled by the infill solar array, thereby facilitating maintenance, solar panel washing, etc.

In some embodiments, an electrical output of an LRPP is increased by adding an infill solar array and using a single, “merged” energy management system (“EMS”). When the ARPP (the infill solar array and any associated ESS capacity) has been installed, the EMS for the solar LRPP can be modified/configured to control the dispatch of energy from both the solar LRPP and the ARPP. Using the single merged EMS can have a similar effect on plant economics as a “repower” event, where the LRPP's solar modules are replaced by newer, more modern, more efficient modules to increase the plant's energy output. In the current example, the legacy solar modules may be left in place while the total energy production may be significantly (e.g., by at least 25%, by at least 33%, by at least 50%, by at least 67%, by at least 75%, and/or the like) increased by the installation of the ARPP.

In some implementations, if energy in the morning is determined (e.g., by the EMS) to be more valuable than energy in the evening, then some or all of the infill solar array racks may be positioned on a west side of the access lanes of the solar LRPP; conversely, if late afternoon/evening energy is more valuable than morning energy, then all the infill solar array racks may be positioned on an east side of the access lanes of the solar LRPP.

In some embodiments, the owner of a solar LRPP may choose to repower the plant, removing the existing solar modules and replacing them with newer, more modern, more efficient solar modules that will increase the plant's energy output. During the implementation of the repower, at any given time a part of the power plant's capacity may be taken offline so that workers can remove the legacy modules and install the new ones. An infill solar array (an ARPP) may be installed on the site, between the LRPP's tracker rows, e.g., prior to or during the repower, to provide additional energy generation during the repower process. By appropriate matching of the repower implementation process and the capacity of surface infill added, any shortfall of energy output from the power plant during the repower process can be reduced or eliminated. In some implementations, at the end of the repower process, the ARPP can be removed from the site. Alternatively or in addition, the ARPP can be installed near the LRPPs that will be last to be repowered, such that the ARPP can operate undisturbed during the repower process. In still other implementations, the ARPP may be installed between LRPPs whose legacy solar modules have been removed, thereby reducing (e.g., minimizing) the shading of the infill solar array by the legacy solar modules. As additional, new solar modules are installed in those rows, and legacy solar modules are removed from the next set of rows, the infill solar array can be quickly/readily repositioned, “walking” with the repower activity as the workers make their way through the legacy array.

As described herein, in accordance with one or more embodiments, energy from an ARPP that is added to an LRPP is delivered to a behind-the-meter load, thereby creating an entirely separate power plant from the LRPP that re-uses the land occupied by the LRPP (i.e., the original power plant) but does not share grid interconnection infrastructure with the LRPP.

The authors are unaware of any known approach to augmenting solar power plants that involves using portable solar racks (e.g., solar arrays that include multiple factory-assembled and pre-wired solar “racks” or subarrays intended to be relatively easily moved by carrying or transporting using wheeled carts) that are to be installed by placing them directly on the ground, rather than a) installed on trackers, or b) installed on previously and separately installed fixed-tilt racking, or c) installed individually, module by module, placed on the ground.

In some embodiments, a method of augmenting an electrical output of a solar LRPP during a repower includes installing an infill solar array in a location (such as between the last tracker rows that will be repowered) where it will not be disturbed during the repowering process. Alternatively or in addition, the infill solar array may be installed in a location where the removal of the older modules will result in reduced (e.g., minimal) shading of the infill solar array but may result in the desire to periodically relocate the infill solar array as the repower activities move from tracker row to tracker row.

In some embodiments, a system for backfilling an LRPP includes a solar panel array, a first electrical interconnection, and a second electrical interconnection. The solar panel array includes a first set of solar panels, each configured to be positioned between at least one pair of adjacent rows of solar panels from a second set of solar panels different from the first set of solar panels, the second set of solar panels being legacy solar panels and electrically coupled to an electrical grid via the first electrical interconnection. The second electrical interconnection is different from the first electrical interconnection, is operably coupled to the first set of solar panels, is not operably coupled to the second set of solar panels, is not operably coupled to the electrical grid, and is configured to connect to at least one of a behind-the-meter load or a behind-the-meter storage. (Note: in other implementations, the second electrical interconnection may be configured to connect the electrical grid and may be operably coupled to the electrical grid.)

In some implementations, each row from the at least one pair of adjacent rows of solar panels includes a single-axis tracker.

In some implementations, the solar panel array is not mechanically coupled to a tracker and is not mechanically coupled to a fixed-tilt rack. In some implementations, a “fixed-tilt rack” refers to a solar panel mounting structure that does not rotate or otherwise move to track the sun.

In some implementations, the solar panel array is sized and shaped such that, when the solar panel array is positioned between the adjacent rows of solar panels from the second plurality of solar panels, an access lane is defined between an edge of the solar panel array and an edge of at least one adjacent solar panel from the second plurality of solar panels. The access lane can have a width of at least one foot, or a width of between about 12 inches and about 18 inches, or a width of between about 15 inches and about 20 inches, or a width of between about 10 inches and about 30 inches, or a width of between about 25 inches and about 50 inches. The solar panel array can thus be designed according to the specific application, or in view of standard practices in solar panel spacings, to ensure that the access lane as above is defined when the solar panel array is positioned between the adjacent rows of solar panels from the second plurality of solar panels. A second access lane may be defined between an edge of the adjacent solar panel from the second plurality of solar panels and an edge of yet another solar panel from the second plurality of solar panels (this solar panel being adjacent the adjacent solar panel from the second plurality of solar panels) or an edge of a second solar panel array.

In some implementations, the solar panel array is a first solar panel array, and the at least one pair of solar panels includes a first solar panel and a second solar panel. The system also includes a second solar panel array configured to be positioned between the second solar panel and a third solar panel from the second plurality of solar panels.

In some implementations, the solar panel array is mounted on a wheeled rack.

In some embodiments, a system for backfilling an LRPP includes a solar panel array, a first electrical interconnection, and a second electrical interconnection. The solar panel array includes a first set of solar panels that are not on trackers, each solar panel from the first set of solar panels configured to be positioned between at least one pair of adjacent rows of solar panels from a second set of solar panels different from the first set of solar panels. The second set of solar panels includes legacy solar panels that are on trackers, and is electrically coupled to an electrical grid via the first electrical interconnection. The second electrical interconnection is different from the first electrical interconnection, is operably coupled to the first set of solar panels, is not operably coupled to the second set of solar panels, and is configured to connect to at least one of a behind-the-meter load, a behind-the-meter storage, or the electrical grid.

In some implementations, the second electrical interconnection is not operably coupled to the electrical grid.

In some embodiments, a system for backfilling an LRPP includes a plurality of solar panel arrays and an electrical interconnection. The plurality of solar panel arrays includes a first solar panel array and a second solar panel array, the first solar panel array being positioned between a first row of legacy renewable energy sources (LRES's) from a plurality of rows of LRES's and a second row of LRES's from the plurality of rows of LRES's, and the second solar panel array being positioned between the second row of LRES's from the plurality of rows of LRES's and a third row of LRES's from the plurality of rows of LRES's. The electrical interconnection is operably coupled to the plurality of solar panel arrays, is not operably coupled to the plurality of rows of LRES's, is not operably coupled to an electrical grid, and is configured to connect to at least one of a behind-the-meter load or a behind-the-meter storage.

In some implementations, the plurality of solar panel arrays and the plurality of rows of LRES's are electrically isolated from one another. Said similarly, the plurality of solar panel arrays and the LRES's do not share any power-carrying conductors or equipment (e.g., no common direct current (DC) strings, no shared inverters, and/or no shared alternating current (AC) buses or transformers) so no current flows between the plurality of solar panel arrays and the LRES's.

In some implementations, each row of LRES's from the plurality of rows of LRES's includes at least one of a solar cell or a wind turbine.

In some implementations, at least one of the first solar panel array or the second solar panel array is mechanically coupled to a wheeled rack.

In some implementations, the first solar panel array is positioned, based on power pricing data, on a westward side of a space between the first row of LRES's and the second row of LRES's.

In some implementations, the first solar panel array is positioned, based on power pricing data, on an eastward side of a space between the first row of LRES's and the second row of LRES's.

In some implementations, each row of LRES's from the plurality of rows of LRES's includes an associated tracker, and no solar panel array from the plurality of solar panel arrays is mechanically coupled to a tracker or a fixed-tilt rack.

In some embodiments, a power plant including an infill solar array includes an EMS and produces power having a different power production profile than a power production profile of the solar LRPP on trackers to which it is added. The different profile may result from the fact that the infill solar array is not on trackers, and/or from the fact that the infill solar array may be affected by shadows from the solar LRPP (note that in some implementations, the inverse may not be true—the solar LRPP is not affected by shadows from the infill solar array, since the infill solar array may be positioned on or close to the ground). The EMS may be capable of/configured to handle the change/differences in power production profiles automatically. The EMS (e.g., stored in controller 314 and/or 316 of FIG. 3) can comprise hardware (e.g., a processor) and/or hardware-executable software that is configured to recognize and integrate the additional generation capacity introduced by the infill solar array. This is achieved, for example, by updating input parameters and generation models to account for the characteristics of the infill solar array such as increased (e.g., maximum) output, voltage range, current limits, and expected production profiles. Once these parameters are incorporated, the EMS can recalibrate its power-flow algorithms to account for the combined output of both the legacy solar array and the infill solar array. The EMS can then dynamically balance load and generation, adjust inverter settings, improve (e.g., optimize) energy dispatch, and maintain stability based on real-time production values. This configuration ensures that the EMS accurately monitors, controls, and reports on total solar generation while preserving safe and efficient operation of the overall electrical network.

In some implementations, if there are any differences between how the solar LRPP equipment is controlled and how the new infill solar/ARPP plant equipment is controlled, the EMS may manage those differences. For example, the EMS may manage the two plants (which use different equipment, possibly with different control codes, different response times, etc.) subject to joint constraints (e.g., the power limit at the point of interconnection to the grid (POGI)). The EMS may charge and discharge batteries with different charge/discharge profiles, etc.

In some embodiments, if a whole power plant (e.g., including the solar LRPP equipment and the new infill solar plant/ARPP equipment) is to be operated as a single power plant, the EMS may modify (or cause a modification to) how the LRPP is operated in ways that involve expanding the scope of responsibility of the EMS. For example, it may be desirable for the overall energy output of the power plant if the tracker movement (of a tracker of the legacy solar power plant) is modified to reflect the presence of the infill solar array. Consider a situation where the LRPP is about to cast a shadow on the edge of the infill solar array. It can be desirable stop the tracker—or even reverse its movement for a predefined period of time—to prevent the shadow from falling on the infill array, thereby prolonging the period of time during which the surface infill solar power plant is producing power. Once the sun angle gets low enough, it can be desirable to (e.g., relatively quickly) move the LRPP to face a direction that increases (e.g., maximizes) the production from the tracker-mounted modules at the cost of throwing shadows on the ARPP modules. While for some known systems, managing tracker orientation is not considered part of the EMS tasks (managing tracker orientation is instead usually left to a separate piece of tracker-controlling software), the joint performance maximization set forth herein, in accordance with some embodiments of the present disclosure, involves the EMS taking over such functionality. If there are energy storage systems (ESS's) deployed around the power plant (e.g., as DC-coupled batteries installed at the locations of the solar inverters), then the different array configurations (whether legacy or infill) may lead to different battery charge/discharge profiles, and the EMS may manage at least the two different battery charge/discharge profiles separately—one for the DC batteries connected to the tracker system and one for the DC batteries connected to the infill array.

While various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium may be transmitted to another computer system via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations, e.g., including cloud-based computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provide by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used herein, in particular embodiments, the terms “substantially,” “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure. The term “substantially,” when referencing a non-numeric value, generally means “to a great or significant extent.” For example, “substantially curved” can refer to a shape that approximates a curve but may not be perfectly symmetrical or curvilinear.

The indefinite articles “a” and “an,” as used herein in the specification and in the embodiments, unless clearly indicated to the contrary, should be understood to mean “at least one.”

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring.

Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every.

Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces.

The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A system, comprising:
a solar panel array including a first plurality of solar panels, each solar panel from the first plurality of solar panels configured to be positioned between at least one pair of adjacent rows of solar panels from a second plurality of solar panels, the second plurality of solar panels being legacy solar panels and electrically coupled to an electrical grid via a first electrical interconnection; and
a second electrical interconnection, the second electrical interconnection operably coupled to the first plurality of solar panels, not operably coupled to the second plurality of solar panels, not operably coupled to the electrical grid, and configured to connect to at least one of a behind-the-meter load or a behind-the-meter storage.

2. The system of claim 1, wherein each row from the at least one pair of adjacent rows of solar panels includes a single-axis tracker.

3. The system of claim 1, wherein the solar panel array is not mechanically coupled to a tracker and is not mechanically coupled to a fixed-tilt rack.

4. The system of claim 1, wherein when the solar panel array is positioned between the adjacent rows of solar panels from the second plurality of solar panels an access lane is defined between an edge of the solar panel array and an edge of at least one adjacent solar panel from the second plurality of solar panels, the access lane having a width of at least one foot.

5. The system of claim 1, wherein the solar panel array is a first solar panel array, and the at least one pair of adjacent rows of solar panels includes a first solar panel and a second solar panel, the system further comprising a second solar panel array configured to be positioned between the second solar panel and a third solar panel from the second plurality of solar panels.

6. The system of claim 1, wherein the solar panel array is mounted on a wheeled rack.

7. The system of claim 1, wherein the first plurality of solar panels are not on trackers, the second plurality of solar panels are different from the first plurality of solar panels, the legacy solar panels are on trackers, the second electrical interconnection is different from the first electrical interconnection, and the second electrical interconnection further configured to connect to the electrical grid.

8. A system, comprising:
a plurality of solar panel arrays including a first solar panel array and a second solar panel array, the first solar panel array being positioned between a first row of legacy renewable energy sources (LRES's) from a plurality of rows of LRES's and a second row of LRES's from the plurality of rows of LRES's, and the second solar panel array being positioned between the second row of LRES's from the plurality of rows of LRES's and a third row of LRES's from the plurality of rows of LRES's; and
an electrical interconnection operably coupled to the plurality of solar panel arrays, not operably coupled to the plurality of rows of LRES's, not operably coupled to an electrical grid, and configured to connect to at least one of a behind-the-meter load or a behind-the-meter storage.

9. The system of claim 8, wherein the plurality of solar panel arrays and the plurality of rows of LRES's are electrically isolated from one another.

10. The system of claim 8, wherein each row of LRES's from the plurality of rows of LRES's includes at least one of a solar cell or a wind turbine.

11. The system of claim 8, wherein at least one of the first solar panel array or the second solar panel array is mechanically coupled to a wheeled rack.

12. The system of claim 8, wherein the first solar panel array is positioned on a westmost side of a space between the first row of LRES's and the second row of LRES's.

13. The system of claim 8, wherein the first solar panel array is positioned, based on power pricing data, on an eastmost side of a space between the first row of LRES's and the second row of LRES's.

14. The system of claim 8, wherein each row of LRES's from the plurality of rows of LRES's includes an associated tracker, and no solar panel array from the plurality of solar panel arrays is mechanically coupled to a tracker.

15. A method, comprising:
positioning a solar array between a first legacy renewable energy source (LRES) and a second LRES, the first LRES and the second LRES being electrically coupled to an electric grid, the first LRES and the second LRES being collocated at a common geographic site; and
electrically coupling, after the positioning, the solar array to at least one of a behind-the-meter load or a behind-the-meter storage, the solar array not being electrically coupled to the electric grid.

16. The method of claim 15, wherein at least one of the first LRES or the second LRES includes an array of solar cells and at least one single-axis tracker.

17. The method of claim 15, wherein at least one of the first LRES or the second LRES includes an array of wind turbines, an access lane being defined between an edge of the solar array and the array of wind turbines.

18. The method of claim 15, further comprising:
selecting, before the positioning, a location for the solar array based on a relative value of energy supplied by the solar array during a morning portion of a day,
wherein the location is between the first LRES and the second LRES,
the positioning including positioning the solar array at the location.

19. The method of claim 15, further comprising:
selecting, before the positioning, a location for the solar array based on a relative value of energy supplied by the solar array during an evening portion of a day,
wherein the location is between the first LRES and the second LRES,
the positioning including positioning the solar array at the location.

20. The method of claim 15, further comprising:
selecting, before the positioning, a location for the solar array based on an amount of shading of the solar array during a predefined portion of a day,
wherein the location is between the first LRES and the second LRES,
the positioning including positioning the solar array at the location.

21. A method, comprising:
positioning at least one solar array between a first legacy renewable energy source (LRES) and a second LRES that are electrically coupled to an electric grid, the first LRES and the second LRES being collocated at a common geographic site; and
electrically coupling, after the positioning, the at least one solar array to the electric grid and at least one of a behind-the-meter load or a behind-the-meter storage.

22. The method of claim 21, further comprising repositioning the at least one solar array during a repowering of at least one of the first LRES or the second LRES.

23. The method of claim 21, wherein the at least one solar array is positioned in an access lane between the first LRES and the second LRES, the method further comprising:
positioning the at least one solar array on one of an eastmost side or a westmost side of the access lane, to mitigate shading effects.

24. The method of claim 23, wherein the access lane is a first access lane, the at least one solar array is a first subset of solar arrays from a plurality of solar arrays, and the method further comprises positioning a second subset of solar arrays from the plurality of solar arrays on one of the eastmost side or the westmost side of a second access lane defined in part by a third LRES.

25. The method of claim 24, wherein solar arrays from the first subset of solar arrays are electrically connected in series in a first circuit, and solar arrays from the second subset of solar arrays are electrically connected in series in a second circuit that is different from, and not electrically connected to, the first circuit.
